(19) United States
(12) Patent Application Publication
(10) Pub. No.: US 2018/0349520 A1
(43) Pub. Date: Dec. 6, 2018

(54) METHODS FOR AGRICULTURAL LAND IMPROVEMENT

(71) Applicant: PIONEER HI-BRED INTERNATIONAL, INC., JOHNSTON, IA (US)

(72) Inventors: GAURAV BHALLA, DES MOINES, IA (US); AHRAZ HUSAIN, DES MOINES, IA (US); RYAN JAY SCHON, ANKENY, IA (US)

(73) Assignee: PIONEER HI-BRED INTERNATIONAL, INC., JOHNSTON, IA (US)

(21) Appl. No.: 15/988,747

(22) Filed: May 24, 2018

Related U.S. Application Data
(60) Provisional application No. 62/513,880, filed on Jun. 1, 2017.

(51) Int. Cl. G06F 17/50; G06N 99/00; G06N 5/04

(52) U.S. Cl. CPC G06F 17/5004; G06N 5/048; G06N 99/005

(57) ABSTRACT

The present disclosure pertains to methods and systems for using soil, weather and terrain data in combination with historical yield data to make field management decisions. Precision farming data may be used in conjunction with the disclosed methods to prioritize field drainage decisions through the addition of drainage tile.

### TECHNICAL FIELD

Embodiments of the present disclosure relate to systems and methods for analyzing agricultural data to improve farm yields.

### BACKGROUND

Farmers have a need to increase yield on the finite area of arable farmland in production. Precision farming, which includes the use of yield monitors, aerial images and soil survey maps generates a large amount of data. There is a need to effectively use this precision farming data to maximize yields.

### SUMMARY

In an embodiment of this invention, soil, weather and terrain data is utilized in combination with historical yield data to make field management decisions. In one embodiment, a method of using precision farming data to prioritize field drainage decisions through the addition of tile is provided.

In one embodiment, different layers of data are analyzed, which layers include a digital tile map of existing field tile. The field is divided into multiple geographical sections, and the digital tile map is overlaid with the historical yield map. Distance to the nearest drainage tile for each field geographical section is calculated. A machine learning or statistical model is used to determine, for each geographical section, a predicted yield with improved drainage across prospective weather scenarios. The geographical section or sections with the highest predicted yield may be selected for improved drainage.

In another embodiment, the model is used to determine, for each geographical section, a variety of crop to be planted on the section in order to maximize yield in a given growing season. For example, a section modeled to have drainage resulting in a soil with a low water holding capacity would be planted with a drought resistant variety with a stable yield pattern in that geographic environment. Conversely, a section modeled to have drainage resulting in non-pooling well hydrated soil would be selected for planting with a standard variety with a high potential yield in good conditions. Likewise, other genetic and/or trait differences between hybrids and/or varieties could be used.

In another embodiment, the method includes predicting an improved yield for field sections with improved drainage by statistical analysis that takes historical weather patterns into account. For example, the model would predict, based on past weather patterns, that the geographical sections would have a probability of a certain percent increase in yield so that the section with the highest probability for yield increase could be predicted and targeted for improved drainage.

In another embodiment, soil phosphorous and potassium levels are analyzed and entered as a feature in the model. The model will adjust the yield results to account for soil phosphorous and potassium levels, thereby more precisely determining the field sections with yields that are most directly impacted by drainage when taking soil phosphorous and potassium levels into account.

In another embodiment, the yield data is cleaned. To be cleaned, the yield data may be clamped between two limits, such as 20 bushels per acre and 350 bushels per acre for corn, and roads and waterways may be clipped out. Further, there may be polygon buffering to remove the edge effects of the field or zone, and the raw or cleaned yield data may be smoothed to reduce the spatial yield variance.

In another embodiment, the file representing the physical location of the tile is converted to a shape file. For example, if the drainage tile is stored in an inherited extensible markup language (XML) format such as Keyhole Markup Language (KML), Keyhole Markup Language Zipped (KMZ) or similar, then the KML file is converted to a shape file by a program that reads the X, Y or X, Y, Z geospatial coordinates from the KML file text and then reconstructs these elements for forming the lines in space and then stores this spatial reconstruction in a shape file format. A similar process may be applied to many of the vector geospatial data formats such as ARCGEN, PCI DSK, SUA, DGN, SEGY, Mapinfo File, GeoJSON, PDS, FileGDB, GPX, DXF, GMT, Idrisi, GPKG, OpenFileGDB, BNA, AeronavFAA, GPSTrackMaker among others by using the appropriate drivers.

In another embodiment, the features in the model are comprised of soil chemical and compositional properties, such as sand content, silt content, organic matter content, electrical conductivity, water holding capacity, and topographical wetness index.

In another embodiment, a topographical map of the area determined to benefit from addition drainage tile may be prepared. To prepare a topographical map, a survey may be taken to determine horizontal and vertical measurements of various elevation points. These horizontal and vertical measurements can be gathered either by using a Global Positioning Systems (GPS) or surveying from a known benchmark. Specific elevation points may be triangulated, and topographical maps developed from the triangulated data set. Other methods and systems may involve collecting data points using survey grade, Real-Time Kinematic (RTK) Differential Global Positioning Systems (DGPS), or by using repeated GPS measurements from non-RTK GPS systems. To generate a topographical map from the RTK system data, the collected data may be transferred to a Computer Aided Design (CAD) program, and the latitude, longitude, and altitude coordinates may be converted into a datum set for compatibility with CAD.

In another embodiment, sensors may be used in conjunction with the model, to provide real time measurement of soil moisture levels and water flow patterns through the field.

In another embodiment, a visual display of the results is provided, which shows the geographic sections by soil type and potential yield, including sections with the highest potential for drainage improvement.

In each embodiment, a computer system is used, which computer system includes a database or a file system for storing agricultural data, including yield data and soil data. A processing unit is configured to run the model and determine the geographic sections that would experience the greatest probability to have the greatest increase in yield.

### BRIEF DESCRIPTION OF THE DRAWINGS

The present disclosure is illustrated by way of example, and not by way of limitation, in the figures of the accompanying drawings and in which:

FIG. 1 illustrates the steps of an embodiment of the method, which may be performed on a computer system that is configured to perform the functions described.

FIG. 2 illustrates an application of the method to Field 1, referred to in Example 1, and shows section 781 of the field, which was identified by the method as the highest potential for yield increase as a result of additional tiling.

FIG. 3 illustrates an application of the method to Field 2, referred to in Example 2, and shows section 4628 of the field, which was identified by the method as the highest potential for yield increase as a result of additional tiling.

### DEFINITIONS

“Aerial Imagery” means aerial images of an agricultural field or geographic section thereof. Aerial images may be obtained by a camera positioned above the field on a support structure, or cameras attached to one or more drones or satellites. Spectra that may be obtained and used from aerial images include spectra indicative of chlorophyll A activity, chlorophyll B activity, carotenoid activity, as well as near infra-red, red edge and ultra-violet spectra.

“Agricultural Drainage Tile” means any water drainage system that is used to channel the flow of water over or through an agricultural field. The drainage tile may include geotextile fibers that act as filters to retain and prevent fine grains of soil from passing in to and clogging the drain, and may be made of any suitable material, such as plastic tubing (HDPE or PVC), precast concrete or ceramic.

“Agricultural Field” means a field used to grow plants of interest. Plants of interest may include any plant grown for food, as well as plants grown for fiber, chemicals, or as ornamentals. Crops of interest may include, but are not limited to, row crops such as corn, soybeans, wheat, sunflower, canola, sorghum and rice.

“Bounding Shape” means the minimum or smallest bounding shape for a set of points in two or three dimensions. The bounding shape will be the smallest measure (either area or volume) within which all the points lie.

“Crop Input” means resources used by farmers to improve yield or enhance grain quality. Examples of crop inputs include seed, fertilizer, insect protection products, seed treatments, herbicides, biologicals, lime, mineral calcium and compost.

“Crop Management Zone” means a geographic section of a field that has similar soil and other crop growth characteristics and may be farmed as unit. A crop management zone may encompass one or more geographic sections. In some embodiments, a crop management zone encompasses at least two or more geographic sections.

“Denitrifying Bioreactor” refers to a structure that uses a carbon source to reduce the concentration of nitrate nitrogen in subsurface agricultural drainage flow via enhanced denitrification. One carbon source that may be effectively used is low tannin wood chips.

“Geographic Section” includes a portion of an agricultural field of any shape. For example, the section may match the shape of precision farming zones in use on the field, or may be a grid pixel of the sizes and shapes described herein.

“Geospatial Coordinates” means a system used in geography that enables every location on earth to be specified by a set of numbers, letters or symbols. Commonly, the coordinates represent latitude, longitude and elevation (X, Y, Z), or may represent latitude and longitude (X,Y).

“Historical Irrigation Data” means the irrigation provided to the field or geographic section thereof. Irrigation data may be recorded by a meter attached to the irrigation equipment. Types of irrigation include, but are not limited to, subsurface textile irrigation, drip irrigation, sprinkler systems, center pivots, lateral move systems, sub-irrigation and in-ground irrigation.

“Historical Weather Data” means the weather recorded for the agricultural field or geographic section thereof. The weather data includes one or more of temperature, humidity, precipitation, wind speed and atmospheric pressure. The weather data also may include solar radiation, ultraviolet index, leaf wetness, soil moisture, soil temperature and other data.

“Historical Yield Data” means yield data from one or more prior seasons indicating yield for an agricultural field or geographic section thereof. Yield data is typically recorded by a grain yield monitor, which is a device in communication with sensors, such as grain mass flow sensor and moisture sensor, to calculate and record the grain yield as the grain is harvested by a harvesting device. In most cases, the yield monitor is coupled with a global positioning system to record yield by field location.

“KML Feature” or “KML Features” means a unicode block containing formatted characteristics (language tag and ASCII character tags). These features are typically language in a plain text stream.

“Machine Learning Analysis” means a computer program that can learn from and make predictions on data by building a model from an example training set of input observations to make data-driven predictions or decisions expressed as outputs.

“Statistical Analysis” means a mathematical formula dealing with the analysis, interpretation and presentation of one or more sets of numerical data. A model based on statistical analysis will use a statistical equation to predict an output.

“Tessellation” or “Tessellating” refers to the tiling of a plane, such as an agricultural field, using one or more geometric shapes, with no overlaps or gaps between the geometric shapes.

“Tile Map” means a map of the drainage systems within an agricultural field or geographic section thereof. A digital tile map refers to a tile map in digital format.

### DETAILED DESCRIPTION

Described herein is a method for determining the predicted drainage of the geographic sections of arable farmland. This information may be used to make land management decisions, such as the placement of additional drainage tiles, and to make crop and/or plant variety placement decisions. Further applications include using the method for other agricultural management decisions, such as the addition and type of irrigation capacity to add, conservation practices, such as where to create terraces, waterways, and/or dry-dams, maintenance of water quality, such as where to create a denitrifying bioreactor, buffer strip, and/or wetland reserve, crop and variety selection, such as which crops and varieties should be planted on a geographic section of land, and crop protection product selection.

It has been found that, by dividing a field into geographic sections and by computing the center of each geographic section to the nearest drainage tile, distance to the nearest drainage tile is a highly informative predictor of yield. This is shown to be the case even in areas of the field where the soil type, soil slope, water level (through irrigation or precipitation), and satellite imagery of plant health, would lead one to conclude that the geographic section is highly productive and additional drainage tile would not be needed. For instance, in the examples shown below, the method predicts that an apparently well drained area of the field with good soil type and in season crop images showing healthy plants, would show a yield improvement from additional tiling that would exceed the yield improvement obtained by adding tiling to low lying damp areas of the field with in season crop images showing unhealthy plants.

A statistical analysis of environmental features affecting yield surprisingly shows that minimum distance (min_dis) to the nearest drainage tile affects yield to approximately the same degree as temperature, precipitation and solar levels, and that addition of drainage tiles can stabilize yields across variable weather years. The results shown below in Table 1 were obtained by rank ordering features based on the absolute value of linear correlation with yield and selecting a sample set of distinct feature categories from the highly correlated ones.

TABLE 1
Statistical Analysis of Environmental Factors Affecting Yield

| | |
|---|---|
| 10_days_mid_min_temp | 0.178632 |
| 10_days_mid_precipitation | 0.179458 |
| 10_days_early_max_temp | −0.18545 |
| 10_days_mid_max_temp | −0.19651 |
| 10_days_early_solar | −0.20803 |
| 10_days_mid_solar | −0.2278 |
| 10_days_early_min_temp | −0.23432 |
| min_dis | −0.2559 |
| 10_days_early_precipitation | −0.30075 |
| year | 0.342747 |
| yield | 1 |

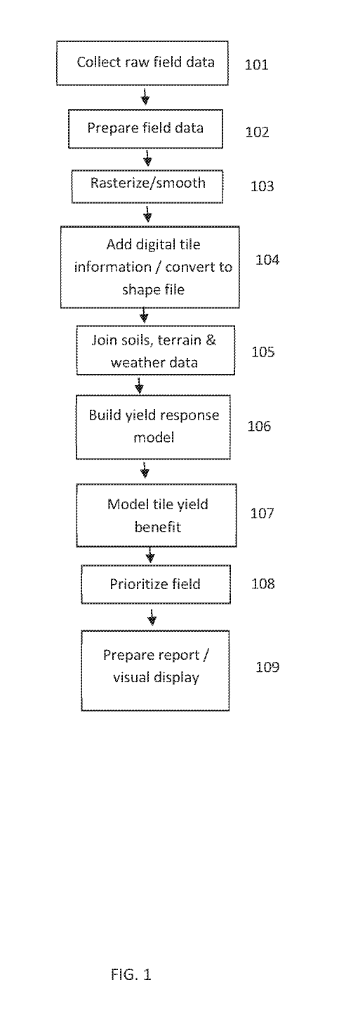

FIG. 1 broadly illustrates steps of the method. Field data, such as yield data, is collected 101, cleaned 102 and smoothed 103. Digital text information, such as a digital file map in text format is converted to a shape file 104. The field data is joined with other field data, such as soil, terrain and weather data 105. A yield response model is developed 106 and applied to model the prospective yield benefit 107. Field or field zones (comprised of the pixels or grids showing the greatest yield benefit) are prioritized 108. A report or visual display of this result may be prepared 109.

In one embodiment, the model involves the steps of developing a yield model based at least on historical yield data and drainage tile location for at least two or more field polygons, applying the model to generate yield responses for each polygon in response to the addition, removal or modification of drainage tile, and providing an output with a predicted yield change as a result of the addition, removal or modification of the drainage tile. The polygons may be of any size or shape. In some embodiments, the polygons are uniform and form a tessellating pattern. Further, in some embodiments, the polygons are equal size square grids. Successful application of the method with both equal sized 3 meter and 5 meter square grids has been used. Larger square grids will result in faster computation of the prediction, while smaller grids will result in greater resolution. In most fields, a 5-meter square grid provided a good balance between speed and computation. However, in fields with high variability in topography or other features, smaller grids may provide higher resolution if needed. Any size grid may be used, from 0.1 meter grids up to about 200 meter grids, or any 0.1-meter grid increment within that range. For a faster calculation, 10 meter square grids may be used. For more efficient resolution determination, the topographical variance may help in this calculation. For example, with fields with minimal change in elevation i.e. a flat field, one may use a lower number of points (such as 20 m) and for a field with a significant variance, one may use a higher resolution (such as 1 m) in an attempt to capture the variability of the underlying agronomical processes on the stated field.

In one embodiment, the method involves collecting yield data. If raw yield data is collected, the data is cleaned by removing implausible data points and rasterized, or smoothed. Yield values are obtained as spatial records of latitude, longitude, and the associated yield measurement. These points are unevenly located in space. Each observation is associated with a putative area measured as the combine head moves forward. The uneven spatial points may be conformed to a uniform polygon, such as a 5×5 grid or any other size or shape patterns as described above, by using the following steps:

(1) an alpha-shape may be constructed as a bounding shape around the raw or cleaned yield files. For example, the alpha shape may be a family of piecewise linear simple curves associated with the shape of a finite set of points;
(2) the alpha shape may be ‘buffered’ in at a fixed offset. This is done to avoid edge effects such as turns by the equipment and/or physical artifacts;
(3) a uniform shape pattern, such as a rectilinear grid, may be defined on the formed alpha shape, with each shape element being defined as a ‘pixel’ (or a pixel cube in the case of 3-dimensional analysis);
(4) all points are converted to mass space by computing the mass at each point as a multiplication between yield and area; and
(5) all the points that fall in each pixel, such as a square polygon, are assumed to be contributing to yield in that pixel. This value may be calculated by summing up the mass contributions and dividing by the area of the pixel.
Alternatively, the above operations can be carried out using a convex hull or bounding box as the alpha shape.

After the attribution and the weight calculation, another program or module may be used to smooth out the variations in the yield values. For example, a ‘Gaussian-blur’ technique may be used, which has been determined to have a good balance of speed of computation and quality. For this process, a filter with known parameters is created and is convolved with the yield raster. This process is done by placing the filter on the pixel and revalidating and re-attributing the pixel's values based on the neighboring pixel's values. For example, one such method involves multiplying the neighboring values with the weights from the filter. The products are then summed and re-attributed as yield. This process results in a smoothened value of the yield for each pixel.

The above program or module may be made in a generic manner to handle different file formats and structures. This is to account for the fact that yield monitors from different equipment providers have different output schemas and varying units of measurement.

The yield raster/matrix from the above step is stored as an array with Universal Transverse Mercator coordinates added to represent physical distances between each yield value. Through this process, each value is a raster pixel centroid, and for pixels in the shape of a grid, represents a grid vertex.

In addition to rasterizing the data, unfarmed areas such as building sites, waterways, buffer strips, wind generators and power line frames may be clipped out. Headland areas near field entry point(s) may be adjusted for increased compaction.

Field drainage line data, which may be entered as a digital tile map, is also collected. The file representing the physical location of the tile is converted to a shape file. For example, if the drainage tile is stored in any inherited extensible markup language (XML) formats such as Keyhole Markup Language (KML), Keyhole Markup language Zipped (KMZ) or similar, then the KML file is converted to a shape file by a program that reads the X, Y or X,Y, Z geographic coordinates from the KML file text, in combination with text elements from the file, and then utilizes these elements to form the lines in space and then store the spatial reconstruction in a shape file format. KML files are non-standard .xml files and may be organized in various ways to represent coordinates, polygons, multi-polygons, structure, line strings, etc. Each tile provider may organize these KML files in different ways, so a method was developed to extract digital tile line information by identifying digital tile line information located in these files.

First, a blueprint for the type of KML file is obtained or created to identify useful information. The blueprint not only identifies direct features identified as tile lines, but abstract elements based on geometry (ring vs. line string), style and/or substyle selector, and camera data. For example, the KML file may include information such as line locations, years, field IDs, natural text with comments, categorical identifiers, etc. The blueprint may utilize features such as placemark names (e.g. “plow run”), geometry type (e.g. “LineString” as vs “Polygon”), color (e.g. red color is the tile, and blue a man-made path) and/or time primitive (e.g. the date the tile data was updated into a shared KML file).

In addition to the information above, each feature is associated with a geospatial location or coordinates (X, Y or X, Y, Z). One feature used is to identify text strings that are within the range of numbers that represent the expected GPS latitude and longitudinal coordinates of the field, with the assumption that these coordinates will identify the field drainage tile locations. Then the points identified are fit within a linear equation (y=mx+b) and line segments are created. For agricultural drainage systems at the same or similar elevations, the X,Y coordinates may be sufficient. Alternatively, or in addition, the elevation or Z coordinate may be used, and the line segment that fits within the equation (x−x1)/(x2−x1)=(y−y1)/(y2−y1)=(z−z1)/(z2−z1) will be created. These line segments may be spatially intersected against known field boundaries to extract and validate relevant tile line strings created by combining two or more line segments. However, such lines may represent the intersection of different tile lines, such as an L-Shape comprised of two different tile lines, so a program is run to split these into two or more tile lines on the basis of the angles of the points making up the tile line strings.

A logic module then identifies features corresponding with identified line segments that potentially represent digital tile lines. These tile lines are tested against known field boundaries to validate that the selected line segments are putative tile lines. This detection of tile lines is automatic, and user interaction, if any, is limited to confirming or validating that the correct information was used to select the tile line and/or that the correct tile line locations were selected. Some advantages of this method are that any KML files formats may be used in an automated system and that only validated tile lines are selected from the KML files (and not other features such as field boundaries).

The field yield raster, which is a grid of yield pixels for a given field, is intersected with the corresponding tile shape file to create ‘tile-features’. Numerous features may be used to determine distance to tile. For example, features such as spatial distance to tile, top 5 least spatial distances to tile, and variance of the top 5 distances to tile have been found to be informative.

The year of installation was identified as an important factor to be considered when attributing the effect of tile placement on the right year. For a given year of placement, the attribution was most accurate when attributed in the following year. For example, if tile in a chosen field is placed in the year 2012, the effect of tile will be attributed to years 2013 and subsequent years. Distance to tile is treated to be as infinite (practically a value of 1e+6 m may be used) for years before a given tile placement year. Different placement years and yield-years provide an intersection between weather patterns and yield, which leads to more accurate modeling and predictions.

Soil, weather, terrain and optionally, hydrology features, are then added. In general, this is accomplished by creating a boundary file that defines polygons in space for that parameter. The data, such as soil, weather, terrain and/or hydrology features are obtained and/or calculated, to associate the pixel to the correct polygon, and, after the intersections are conducted, all of the relevant data-sets are joined and larger matrices are populated in memory. Pixels that fall on edges of polygons may be discarded. Following this step, each pixel and grid vertex (if a grid is used) will include yield, soil, terrain, hydrology and/or weather data.

Soil, terrain, hydrology and weather data formats and values that may be used include one or more of the publicly available features from SSURGO soils which are available at (Natural Resources Conservation Service, United States Department of Agriculture. Soil Survey Geographic (SSURGO) Database. Available online at sdmdataaccess.sc.egov.usda.gov) and (Natural Resources Conservation Service, United States Department of Agriculture. Web Soil Survey. Available online at websoilsurvey.nrcs.usda.gov). The feature descriptions that may be used comprise any one or more of the attributes that represent the physical (e.g. sand, silt, clay), chemical (e.g. available nitrates, cations capacity, ph), biological (e.g. organic matter) soil properties, the first and second derivative terrain attributes (e.g. slope, catchment, area over curve network), hydrology functions (e.g. soil influenced topographical wetness index) and weather (e.g. temperature, solar radiation and precipitation patterns) among others.

The soil data may be obtained from any number of sources, such as the SSURGO database available from the USDA (Natural Resources Conservation Service, United States Department of Agriculture. Soil Survey Geographic (SSURGO) Database. Available online at sdmdataaccess.sc.egov.usda.gov) and (Natural Resources Conservation Service, United States Department of Agriculture. Web Soil Survey. Available online at websoilsurvey.nrcs.usda.gov). Actual field soil samples may be used directly for the respective grid being analyzed, or may be used to correct the soil survey data attributed to such grid. Alternatively, the soil survey data may be adjusted to account for known soil topography, such as soil elevation and slope. In one embodiment, a unique Mukey (map unit key), weather and digital terrain attributes are created from boundary file. Known soil attributes may be connected to the appropriate Mukey. The resultant arrays may then be spatially joined with the base yield vector.

In a further description of this and other embodiments, a yield response model is then developed. The yield model is combined with a tile model to create a hybrid model that can be used to provide a yield estimate for any tile scenario, including a scenario showing the benefit of any amount of additional tile.

In one embodiment, a boosted regression tree model may be used. When a boosted regression tree model is used, the data is aggregated by clustering and distribution. 2-way interactions are tested for significance to determine which characteristics of the grid cell are most predictive of yield. A boosted regression tree model is utilized to map yield to tile features, soils, terrain and weather data. The result is then validated, and may be further cross-validated on the training data by leaving out random field data and using hyper-parameter tuning to train the final model. Other well-known statistical methods that may be used include but are not limited to a stepwise regression model, a particle swarm optimization method, and an ant colony optimization method.

In another embodiment, or in addition to the use of a statistical model, a machine learning or artificial intelligence framework can be deployed. To deploy this embodiment, a yield matrix is divided into separate train and test sets. The training data is exposed to the machine learning framework to model the yield as a function of tile, soils, weather and terrain data. The train and test sets are created on the basis of separate fields. For example, if the yield matrix has data from 10 different fields, fields 1 through 8 form the training set and fields 9 through 10 are left as test sets. The split is done in a random fashion. The training data set is further divided into different folds and used for cross-validation. This is again done by randomly splitting on the basis of fields. Each cross validation round will provide an estimate of test-error. A hyper-parameter search for the machine learning framework is then performed over the cross validation rounds. The parameter combination which gives the least validation error is selected, and final performance is assessed over the test set. Once the final model is run over the entire data set it is used for predictions.

To determine the value of additional drainage tile at a specific grid cell, test drainage tile is included as a variable. Variable tile scenarios are fully modeled for each field polygon, such as by modeling the status quo tiling (such as 60 foot spaced drainage tile) as versus drainage tile at a test tile density, such as one half (30 foot spaced drainage tile) or one third (20 foot spaced drainage tile). In general, the higher the resolution of the field grid (e.g. 5-meter grid versus a 20-meter grid), the better the model will perform. The final model is then used to predict yields per grid cell at the current drainage tile density as well as at a test tile density. The modeled yields at the current density are used to determine the benefit of adding yield tile at the test density.

Optionally, a report may be generated that illustrates the grids with the highest yield increase as a result of additional drainage tile.

The data used to perform the method may be stored in multiple data formats. For example, data such as yield monitor harvest data, as-planted seeding data and spray data, will likely be logged as FCD (frequently changing data). Other layers, such as soil sample points, tile lines, variety polygons, activity date, soil phosphorous level, soil potassium level, tile size, etc. may be stored on line in any number of data formats, such as .shp and/or .dat files. Therefore, in one embodiment, the data used in the method is brought forward into a single server and placed in a data lake format, which allows the co-existence of structured, semi-structured, unstructured and raw data.

The method may be implemented with various forms of drainage tile and/or drainage systems, such as surface drainage and/or sub-surface drainage. Surface drainage systems consist of reshaped or reformed land surfaces, and can comprise bedded systems and graded systems. Ridges and furrows may be used to direct the water to more desirable locations, including to subsurface drainage systems. The subsurface systems may involve drainage by gravity or by pumps, and may comprise control gates that can be opened or closed to control the flow rate of the water. Subsurface drainage systems typically comprise corrugated, flexible and perforated plastic (PE or PVC) pipe lines. The pipe lines may be wrapped with a material that serves to block soil particles from entering the pipes. In some environments, where the ground has sufficient natural drainage, it may be possible to alter subsurface drainage by breaking up permeable soil layers by deep plowing.

Field sensors may be used in conjunction with the model. The sensors include soil moisture sensors that measure water content, such as neutron probes, time domain transmissivity and capacitance sensors, as well as sensors that measure soil water tension, such as tensiometers and granular matrix sensors. Optimally, sensor measurements are taken at field capacity (the maximum amount of water that the soil can hold), which can be compared to values obtained as the water drains. The rate of drainage can be utilized as a feature in the model or compared to model to assess the regions predicted to have the greatest yield benefit from additional tile placement.

The model also has application to the use of aerial imagery, such as images obtained by drones and/or satellites. Such images may be used to show areas of ponding and the rate of drainage, or areas of drought and the rate of crop recovery following a watering event. When combined with the data from the methods described herein, and the actual and modeled yield estimates obtained from these methods, aerial images from different sources and/or times may be calibrated with the model to provide more accurate estimates of crop yield, plant stand, field drainage, field irrigation need and effects, and the like. Further, aerial imagery can be compared to the digital tile map and/or model output to evaluate the effectiveness of the existing tile on the field. In addition, aerial imagery can be utilized in place of the digital tile map when a digital tile map is not available.

Digital tile maps that may be utilized in the embodiments described herein include tile maps that may be created through various methods. While the tile map may be provided in connection with tile installation, tile may also be mapped through ground penetrating radar, analysis of aerial imagery, or soil analysis. Since drainage tile trenches are often filled with clay soil, in such cases it is possible to analyze the soil type or amount of compaction to deduce the location of the drainage tile lines. Method of doing this include using a “direct push” machine, which is pushed into the ground without the use of drilling to remove soil or to make a path for a tool. Some seed planting equipment may take a measurement of the soil properties or compaction, and this measurement can be used to deduce soil type and/or compaction and therefore, location of drainage tiles.

### Example 1

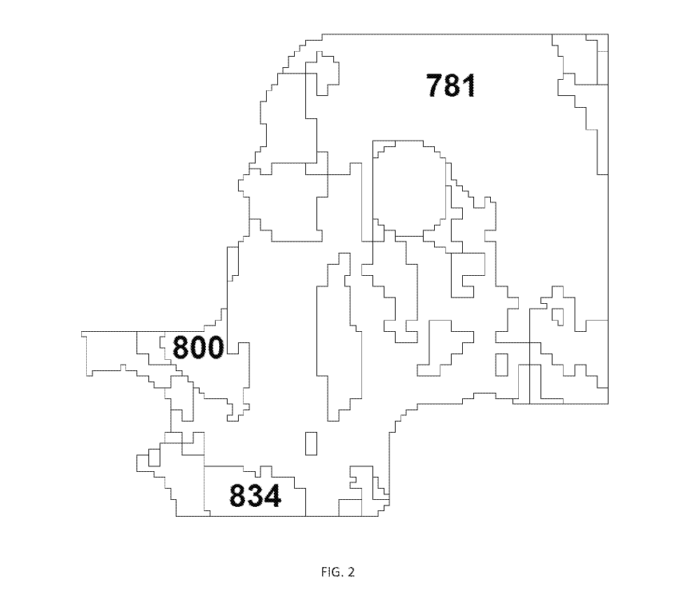

The model was created and applied to field A, which is located in Iowa with a mixture of soils and topographies, including Bolan loam on 0 to 2 percent slopes, Canisteo clay loam on 0 to 2 percent slopes, Clarion loam on 2 to 6 percent slopes, Fieldon loam on 0 to 2 percent slopes, Harps clay loam on 0 to 2 percent slopes, Linder sandy loam with a depth of 32 to 40 inches, Mayer loam on 0 to 2 percent slopes, Nicollet clay loam on 1 to 3 percent slopes, Okoboji silty clay loam on 0 to 1 percent slopes, Ridgeport sandy loam on 0 to 2 percent slopes, and Webster clay loam on 0 to 2 percent slopes. A digital field tile map was obtained and divided into a 5 meter by 5 meter grid. Historical yield and other data including a large number of soil, terrain and weather and derived features, including distance to tile, were obtained and a yield model was developed. The yield map was overlaid with the tile map using the methods described above. The yield model was run based on 10 years of historical weather data to provide a representative range of weather years as a prediction for future weather patterns, since drainage tile may have a significant benefit in a wet year, but little or no benefit in a dry year. The model was run for each year of weather data and the predicted yield for each weather year was calculated for each 5 meter by 5 meter grid. Grids with similar increases (or decreases) in predicted yield were clustered and aggregated into a field sector. For example, as shown in Table 2, field sector 781 comprises an aggregate of 5 meter by 5 meter grids totaling 40,950 square meters. The application of the model showed that a mean yield increase should result from additional tile drainage. Moreover, in wet years, a larger yield increase could be expected. As shown in Table 3, an improvement in field sector 781 of at least 5 bu/acre was predicted based on the weather in 9 out of 10 of the last weather years, an improvement of at least 10 bu/acre was predicted based on the weather in 8 out of 10 of the last weather years, and an improvement of at least 20 bu/acre was predicted based on the weather in 4 out of 10 of the last weather years. This result was surprising, since field sector 781 appeared to be well drained, has a high yielding Nicollet clay loam soil type, and field imagery taken by satellite of the crop on Jun. 27, 2016 showed healthy crops in sector 781 as versus other sectors of the field, such as 800 and 834. FIG. 2 shows the position of these 3 sectors in the field.

TABLE 2
Example 1, Model Yield Output for 10 years of Weather

| | | | | | | | | | | | | Mean |
|---|---|---|---|---|---|---|---|---|---|---|---|---|
| Field | | | | | | | | | | | | Yield |
| Sector | Area | 2006 | 2007 | 2008 | 2009 | 2010 | 2011 | 2012 | 2013 | 2014 | 2015 | Increase |
| 781 | 40,950 | 33.7 | 18.6 | 18.6 | 20.1 | 42.1 | 38.6 | 7.7 | 18.0 | −2.1 | 19.9 | 21.5 |
| 834 | 3,525 | 21.7 | 4.9 | 25.5 | 23.6 | 24.1 | 23.1 | 7.2 | 28.2 | 8.8 | 5.1 | 17.2 |
| 800 | 3,850 | 16.2 | 7.6 | 23.5 | 18.8 | 16.3 | 17.7 | 12.0 | 25.4 | 11.7 | 7.8 | 15.7 |

TABLE 3
Example 1, Model Yield Output

| | | Standard | | Diff 10 | Diff 20 |
|---|---|---|---|---|---|
| Field Sector | Mean | Deviation | Diff 5 bu/ac | bu/acre | bu/acre |
| 781 | 21.5 | 12.8 | 9 | 8 | 4 |
| 834 | 17.2 | 9.0 | 9 | 6 | 6 |
| 800 | 15.7 | 5.7 | 10 | 8 | 2 |

### Example 2

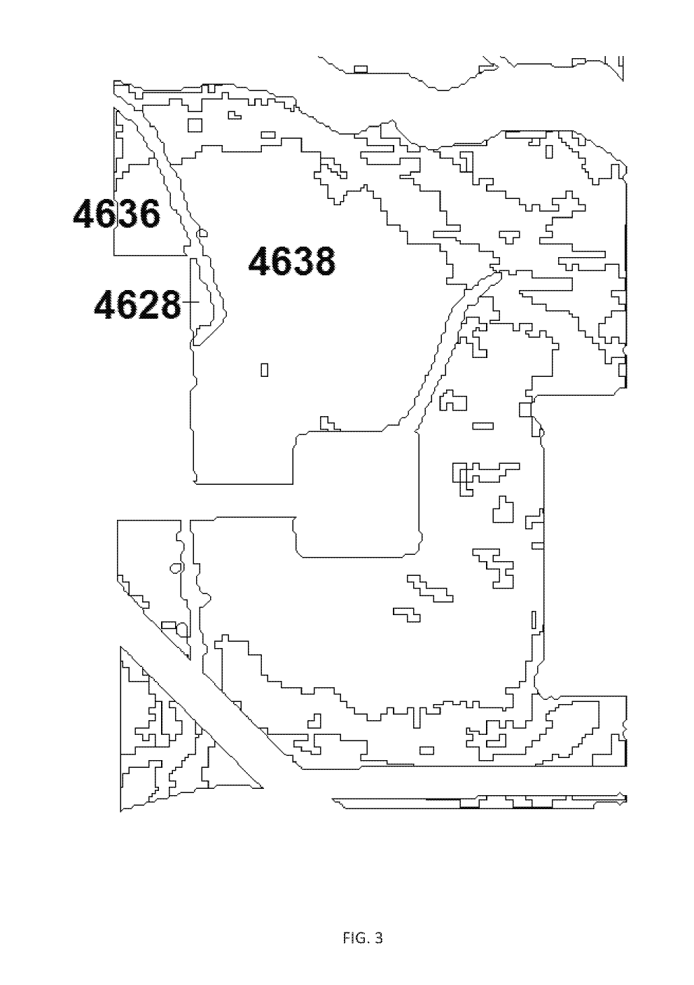

The model was created and applied to field B, which is located in Iowa with a mixture of soils and topographies of over 50 types, including field sectors 4628, 4638 and 4636, consisting mostly of a Clyde-Floyd soil complex. A digital field tile map was obtained and divided into a 5 meter by 5 meter grid according to the method described in above. Historical yield and other data including a large number of soil, terrain and weather and derived features, including distance to tile, were obtained and a yield model was developed. The yield map was overlaid with the tile map using the methods described above. The yield model was run based on 10 years of historical weather data to provide a representative range of weather years as a prediction for future weather patterns. The model was run for each year of weather data and the predicted yield for each weather year was calculated for each 5 meter by 5 meter grid. Grids with similar increases (or decreases) in predicted yield were clustered and aggregated into a field sector. The application of the model showed that a mean yield increase should result from additional tile drainage. As shown in Table 4, a mean yield improvement ranging from 15.8 to 22.9 bu/acre was predicted for field sectors 4628, 4638 and 4636, with a likelihood of at least 5 bu/acre predicted in each of the last 10 years for field sectors 4628 and 4638 and in 9 out of 10 of the last weather years for field sector 4636. FIG. 3 shows the position of these sectors in the field.

TABLE 4
Example 2, Model Yield Output for 10 years of Weather

| | Mean Yield | Standard | Diff 5 | Diff | Diff |
|---|---|---|---|---|---|
| Field Sector | Increase | Deviation | bu/ac | 10 bu/ac | 20 bu/ac |
| 4628 | 22.9 | 18.6 | 10 | 10 | 6 |
| 4638 | 16.8 | 4.9 | 10 | 8 | 3 |
| 4636 | 15.8 | 7.6 | 9 | 5 | 3 |

Although the methods described herein have been primarily described with respect to tile management, the methods can be used for other agricultural management decisions, such as the addition and type of irrigation capacity to add, conservation practices, such as where to create terraces, waterways, and/or dry-dams, maintenance of water quality, such as where to create a denitrifying bioreactor, buffer strip, and/or wetland reserve, crop and variety selection, such as which crops and varieties should be planted on a segment of land, and crop protection product selection. For example, the model may suggest one variety of corn, such as a drought resistant variety, in one geographic section, and a higher yielding less drought resistant variety in another. With regard to crop selection, the model may suggest planting a cover crop to assist with nitrate reduction, or which row crops to plant in a given season.

What is claimed is:

1. A method of agricultural drainage tile placement, comprising:
obtaining historical yield data for an agricultural field, wherein the field is divided into geographic sections and the historical yield data is allocated to or computed for each geographic section,
obtaining historical weather data for the field,
computing a distance of each geographic section to the nearest drainage tile,
running a statistical or machine learning analysis based on the historical weather data, the historical yield data and the distance of each geographic section to the nearest drainage tile to determine a model of the yield response of the geographic section to alternative weather scenarios, and
utilizing the model to determine the geographic sections that will have the greatest probability of yield increase due to a decreased distance to the nearest drainage tile.

2. The method of claim 1, wherein the historical weather data is precipitation data.

3. The method of claim 1, further comprising the use of historical irrigation data in addition to the historical weather data.

4. The method of claim 1, wherein the geographic sections are crop management zones.

5. The method of claim 1, wherein the geographic sections are tessellating geometric shapes.

6. The method of claim 5, wherein the distance of each geographic section to the nearest drainage tile is calculated based on the distance from the center point of the geometric shape to the nearest point of drainage tile.

7. The method of claim 6, wherein the tessellating geometric shapes create a 5 meter by 5 meter grid.

8. The method of claim 1, wherein each geographic section also comprises soil and terrain features.

9. The method of claim 8, wherein the terrain features include hydrology measurements of water flow over or within the soil.

10. The method of claim 1, wherein the drainage tile information is extracted from a text file.

11. The method of claim 10, wherein the extraction is accomplished by the steps of:
identifying and selecting KML features associated with geospatial coordinates,
validating the geospatial coordinates by fitting the geospatial coordinates to a linear equation to create line segments, and
spatially intersecting the geospatial coordinates with field boundaries.

12. A method of making agricultural land management decisions based on yield, comprising:
obtaining historical yield data for an agricultural field, wherein the field is divided into geographic sections and the historical yield data is allocated to or computed for each geographic section,
obtaining historical weather data for the field,
obtaining soil data for the field,
constructing a bounding shape around the yield files,
identifying and selecting KML features associated with geospatial coordinates,
spatially intersecting the geospatial coordinates within the bounding shape,
running a statistical or machine learning analysis based on the historical weather data and the historical yield data to determine a model of the yield response of the land management decision to alternative weather scenarios based on the soil type, and
utilizing the model to determine the geographic sections that will have the greatest probability of yield increase due to the land management decision.

13. The method of claim 12, wherein the land management decision is at least one member of a group consisting of: the placement of agricultural drainage tile, the type of the type of crop to plant in the geographic section, the type of plant variety to plant in the geographic section, the addition of irrigation to the geographic section, the type of irrigation to add to the geographic section, the use of one or more conservation practices, such as the addition of terraces, waterways or dry-dams to the geographic section, the addition of denitrifying bioreactors, buffer strips or wetland reserves to the geographic section, and the type of crop input to add to the geographic section.

14. A method of making agricultural drainage tile placement, comprising:
obtaining historical yield data for an agricultural field, wherein the field is divided into geographic sections and the historical yield data is allocated to or computed for each geographic section,
obtaining historical weather data for the field,
obtaining aerial imagery indicative of water drainage,
running a statistical or machine learning analysis based on the historical weather data, the historical yield data and the aerial imagery to determine a model of the yield response of the geographic section to alternative weather scenarios, and
utilizing the model to determine the geographic sections that will have the greatest probability of yield increase due to a decreased distance to the nearest drainage tile or an improvement in drainage tile efficiency.

15. The method of claim 14, wherein the method further comprises obtaining a digital tile map.

16. The method of claim 15, wherein the digital tile map is obtained by:
identifying and selecting KML features associated with geospatial coordinates, and
spatially intersecting the geospatial coordinates with field boundaries.

17. The method of claim 14, wherein the geographic sections are a grid.

18. The method of claim 14, wherein the data is associated to each geographic section by:
constructing a bounding shape around the yield files,
buffering the bounding shape to remove a fixed width boundary, and
creating a uniform shape pattern on the formed bounding shape.

19. The method of claim 14, wherein each geographic section also comprises soil and terrain features.

20. The method of claim 19, wherein the soil and terrain features include soil water sensor measurements.
